(19) United States
(12) Patent Application Publication
(10) Pub. No.: US 2013/0162046 A1
(43) Pub. Date: Jun. 27, 2013

(54) MULTI ENERGY HARVESTING SYSTEM

(71) Applicants: Chien-Chun Lu, Tainan City (TW); Chao-Jen Huang, Taichung City (TW); You-Wei Liang, Taoyuan County (TW)

(72) Inventors: Chien-Chun Lu, Tainan City (TW); Chao-Jen Huang, Taichung City (TW); You-Wei Liang, Taoyuan County (TW)

(21) Appl. No.: 13/458,816

(22) Filed: Apr. 27, 2012

(30) Foreign Application Priority Data
Dec. 23, 2011 (TW) 100148227

(51) Int. Cl. H02J 1/00

(52) U.S. Cl. 307/72

(57) ABSTRACT

A multi energy harvesting system is provided. The system includes: a DC energy source harvesting circuit, having a DC energy source harvesting unit for generating a DC based on a first physical quality, and a first DC to DC converter for adjusting voltage of the DC; an AC energy source harvesting circuit, having an AC energy source harvesting unit for generating an AC based on a second physical quality and a rectifier for rectifying the AC; and an assistance circuit, coupled between the DC energy source harvesting circuit and the AC energy source harvesting circuit, for increasing efficiency thereof.

### CROSS REFERENCE TO RELATED APPLICATIONS

This Non-provisional application claims priority under 35 U.S.C. §119(a) on Patent Application No(s).100148227, filed in Taiwan, Republic of China on Dec. 23, 2011, the entire contents of which are hereby incorporated by reference.

### BACKGROUND OF THE INVENTION

1. Field of the Invention

The present invention is related to an energy harvesting technology.

2. Description of the Related Art

An energy harvesting apparatus is a device for gathering and saving power from external power sources. The energy harvesting apparatus can be integrated into various circuits for various purposes.

The energy harvesting apparatus is particularly suitable for use in mobile communications or biomedical systems. However, with limited power sources, the energy harvesting apparatus used in those systems can only provide low power energy. Also, the switching or energy converting units in the energy harvesting apparatus additionally consume power, thus worsening efficiency of the energy conversion of the entire apparatus. To improve the efficiency, in the prior art, there may be an additional (secondary) energy harvesting apparatus, which is disposed with the primary energy harvesting apparatus and used for assisting the primary one to generate more power. But, the secondary energy harvesting apparatus can not generate power by itself, thus limiting its usage.

Therefore, the present invention provides a multi energy harvesting system, which can not only gather energy from all sorts of power sources but also improves the efficiency of the entire energy harvesting apparatus.

### BRIEF SUMMARY OF THE INVENTION

The present invention provides a multi energy harvesting system. The system includes a DC energy source harvesting circuit, having a DC energy source harvesting unit for generating a DC based on a first physical quality, and a first DC to DC converter for adjusting voltage of the DC; an AC energy source harvesting circuit, having an AC energy source harvesting unit for generating an AC based on a second physical quality and a rectifier for rectifying the AC; and an assistance circuit, coupled between the DC energy source harvesting circuit and the AC energy source harvesting circuit, for increasing efficiency thereof.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic diagram of a multi energy harvesting system of the present invention.

FIG. 2 is a detailed schematic diagram of the multi energy harvesting system of the present invention.

FIG. 3 is another detailed schematic diagram of the multi energy harvesting system of the present invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

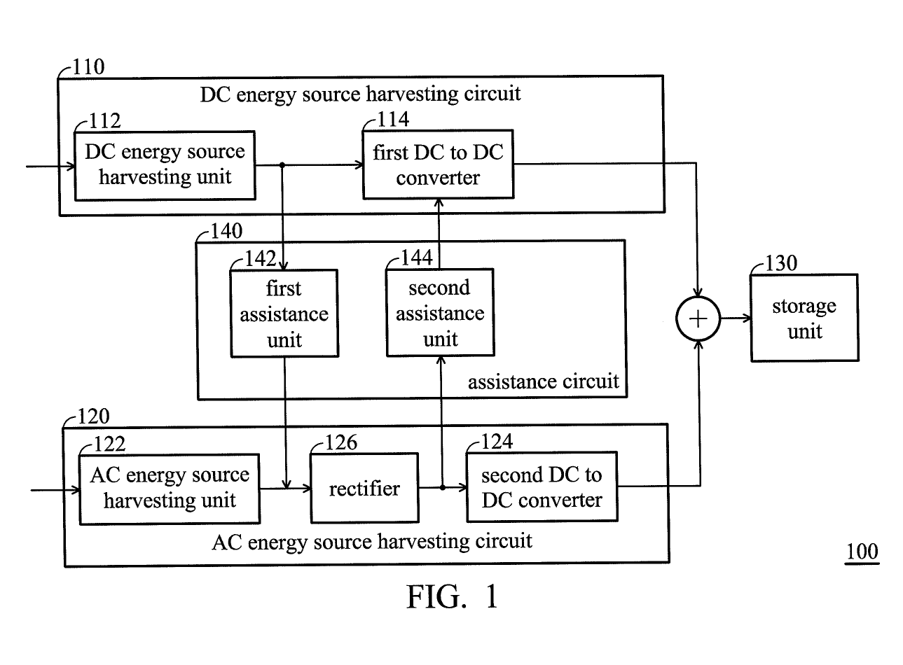

FIG. 1 is a schematic diagram of a multi energy harvesting system of the present invention. The multi energy harvesting system 100 of the present invention, used for extracting energy in various forms, comprises a DC energy source harvesting circuit 110, an AC energy source harvesting circuit 120, a storage unit 130 and an assistance circuit 140. The DC energy source harvesting circuit 110 comprises a DC energy source harvesting unit 112, which can generate a direct current based on a first physical quality. The DC energy source harvesting circuit 110 further lets the (processed) direct current stored into the storage unit 130. The first physical quality, for example, can be thermal or optical energy. Similarly, the AC energy source harvesting circuit 120 comprises an AC energy source harvesting unit 122, which can generate an alternating current based on a second physical quality. The AC energy source harvesting circuit 120 further lets the (processed) alternating current stored into the storage unit 130. The second physical quality, for example, can be mechanical or electromagnetic energy. The storage unit 130 can be further connected to various circuits having various functions for providing the stored energy thereto.

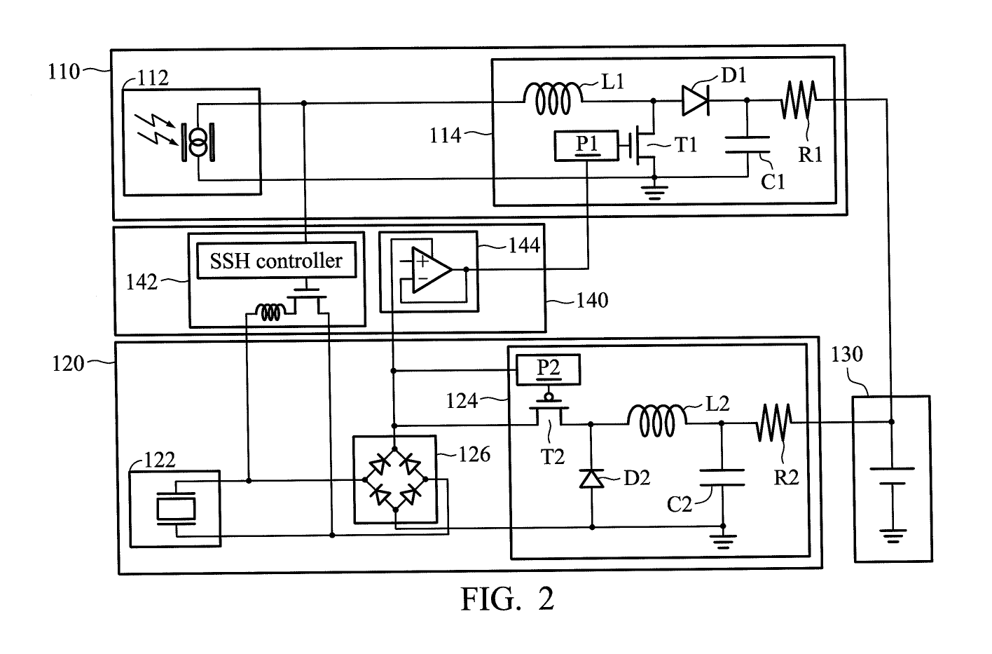

It can be found that the multi energy harvesting system 100 of the present invention uses different circuits for gathering different sorts or energy (in AC or in DC) when the energy is inputted thereto. Through this manner, the different sorts of energy gathered in the system can be used for “assisting” each other for improving the efficiency of the entire system. The DC energy source harvesting unit 112 and the AC energy source harvesting unit 122 of the present invention can be embodied by various transducers. For example, as shown in FIG. 2, the DC energy source harvesting unit 112 is a thermoelectric component for converting thermal energy (i.e., the first physical quality) into the direct current, and the AC energy source harvesting unit 122 is a piezoelectric component for converting mechanical energy (i.e., the second physical quality) into the alternating current. However, in other embodiments, the said thermoelectric component can be replaced by any transducer which is able to generate the direct current, for example, a photoelectric component, and similarly, the said piezoelectric component can be replaced by any transducer which is able to generate the alternating current, for example, a radio frequency antenna. Note that, although there is a single DC energy source harvesting circuit 110 and a single AC energy source harvesting circuit 120 which are described in the embodiments, the number of those two harvesting circuits 110 and 120 should not be limited thereto, and those skilled in the art can add, omit or alter the components described above according to the concept of the present invention.

In the present invention, each of the DC energy source harvesting unit 112, the AC energy source harvesting unit 122 and the storage unit 13 has different voltage levels. For example, in an embodiment, the voltage level of the storage unit 130 is about 1V, the voltage level of the thermoelectric component 112 is about 0.2-0.6V, slightly lower than that of the storage unit 130, and the voltage level of the piezoelectric component voltage of 122 varies between ±3.7V with a root-mean-square value which is higher than the voltage level of the storage unit 130. To match the voltage level of the storage unit 130, the DC energy source harvesting circuit 110 additionally has a first DC to DC converter 114. The first DC to DC converter 114 is coupled to the DC energy source harvesting unit 112, and used for adjusting the voltage outputted from the DC energy source harvesting unit 112. Similarly, the AC energy source harvesting circuit 120 additionally has a rectifier 126 and a second DC to DC converter 124, where the rectifier 126 is coupled to the AC energy source harvesting unit 122 for rectifying the alternating current (to be a direct current with about 3V), and the second DC to DC converter 124 is coupled to the rectifier 126 for further adjusting the rectified alternating current. Specifically, in this embodiment, the first DC to DC converter 114 should be a boost converter, which is used for lifting the voltage level of the DC energy source harvesting unit 112 from about 0.2-0.6V to the voltage level of the storage unit 130 (1V), while the second DC to DC converter 124 should be a buck converter for lowering the voltage level of the AC energy source harvesting unit 122 from about 3V to that of the storage unit (1V). FIG. 2 is a schematic diagram of the multi energy harvesting system based on the present invention. In an embodiment, as shown in FIG. 2, the first DC to DC converter 114 is basically composed of a capacitor C1, an inductor L1, a resistor R1 and a diode D1, and has a voltage which can be controlled by a transistor switch T1 and a pulse width modulation (PWM) signal generator P1. Similarly, the second DC to DC converter 124 is basically composed of a capacitor C2, an inductor L2, a resistor R2 and a diode D2, and has a voltage which can be controlled by a transistor switch T2 and a PWM signal generator P2. Note that the components in this embodiment are shown for illustration, and the present invention should not be limited thereto.

The present invention is further characterized by the use of the assistance circuit 140. The assistance circuit 140 is used to make the DC energy source harvesting circuit 110 and the AC energy source harvesting circuit 120 assist each other for improving the entire energy conversion efficiency. The assistance circuit 140 of the present invention, coupled between the DC energy source harvesting circuit 110 and the AC energy source harvesting circuit 120, comprises a first assistance unit 142 and a second assistance unit 144. The first and the second assistance unit 142 and 144 will be described in detail below.

The first assistance unit 142 of the present invention is a power factor correction circuit, which is coupled between the output of the DC energy source harvesting unit 112 and the input of the AC energy source harvesting unit 122, and can use the direct current generated by the DC energy source harvesting unit 112 to improve the efficiency of the AC energy source harvesting circuit 120. In an embodiment, as shown in FIG. 2, the first assistance unit 142 may be composed of a synchronized switch harvesting (SSH) controller, a transistor switch and an inductor, or, in another embodiment, composed of a synchronized switch harvesting controller and a transistor switch. The assistance unit 142 can make the voltage and the current of the alternating current generated by the AC energy source harvesting circuit 120 as simultaneous as possible (i.e., reduce the phase difference therebetween), thus improving the power factor of the AC energy source harvesting circuit 120 and decreasing the power consumed by the AC energy source harvesting circuit 120. It should be noted that the SSH controller can be replaced by a SSHI (Synchronized Switch Harvesting in Inductor) controller. In other embodiments, the first assistance unit 142 of the present invention can be replaced by any circuit which can correct a power factor of electricity.

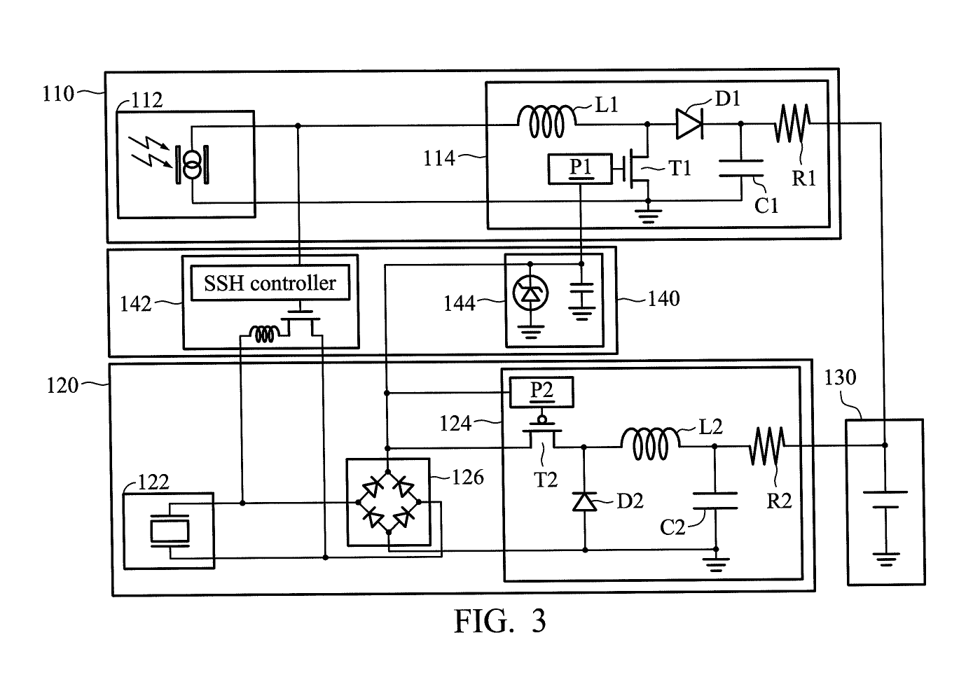

The second assistance unit 144 of the present invention is coupled between the output of the rectifier 126 and the input of a pulse width modulation (PWM) signal generator P1 in the first DC to DC converter 114, and can use the alternating current rectified by the rectifier 126 of the AC energy source harvesting circuit 120 to improve the efficiency of the first DC to DC converter 114. For example, as shown in FIG. 2, the second assistance unit 144 is a linear regulator, which uses the stable voltage to control the PWM signal generator P1. Therefore, the PWM signal provided by the PWM signal generator P1 can control the transistor T1 to turn on or off precisely. When the efficiency of the DC to DC converter 114 is improved, the efficiency of the DC energy source harvesting circuit 110 can also be improved. It should be noted that, in another embodiment, the second assistance unit 144 can be a voltage regulator comprising a Zener diode and a capacitor as shown in FIG. 3, but the present invention should not be limited thereto.

With the function of the assistance circuit 140, the multi energy harvesting system 100 of the present invention can reduce unnecessary power consumption, improve its entire energy conversion efficiency, and thus increase it use.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A multi energy harvesting system, comprising:
a DC energy source harvesting circuit, comprising:
a DC energy source harvesting unit, for generating a direct current (DC) based on a first physical quality; and
a first DC to DC converter, coupled to the DC energy source harvesting unit, for adjusting voltage of the DC;
an AC energy source harvesting circuit, comprising:
an AC energy source harvesting unit, for generating an alternating current (AC) based on a second physical quality; and
a rectifier, coupled to the AC energy source harvesting unit, for rectifying the AC; and
an assistance circuit, coupled between the DC energy source harvesting circuit and the AC energy source harvesting circuit, for increasing efficiency of the AC energy source harvesting circuit by using the DC generated by DC energy source harvesting unit, and increasing efficiency of first DC to DC converter by using the AC provided by the rectifier.

2. The multi energy harvesting system as claimed in claim 1, wherein the assistance circuit comprises:
a first assistance unit, coupled between output of the DC energy source harvesting unit and input of the rectifier, for controlling a power factor of the alternating current.

3. The multi energy harvesting system as claimed in claim 1, wherein the assistance circuit comprises:
a second assistance unit, coupled between output of the rectifier and a pulse width modulation (PWM) signal generator of the first DC to DC converter.

4. The multi energy harvesting system as claimed in claim 2, wherein the first assistance unit comprises a synchronized switch harvesting (SSH) circuit.

5. The multi energy harvesting system as claimed in claim 2, wherein the first assistance unit comprises a synchronized switch harvesting circuit in inductor (SSHI).

6. The multi energy harvesting system as claimed in claim 3, wherein the second assistance unit is a linear regulator.

7. The multi energy harvesting system as claimed in claim 3, wherein the second assistance unit comprises a Zener diode and a capacitor.

8. The multi energy harvesting system as claimed in claim 1, wherein the AC energy source harvesting circuit further comprises a second DC to DC converter, coupled to the rectifier, for adjusting voltage of the rectified AC.

9. The multi energy harvesting system as claimed in claim 1, wherein the first DC to DC converter is a boost converter.

10. The multi energy harvesting system as claimed in claim 8, wherein the second DC to DC converter is a buck converter.

11. The multi energy harvesting system as claimed in claim 1, further comprising a storage unit, coupled to the DC energy source harvesting circuit and the AC energy source harvesting circuit.

12. The multi energy harvesting system as claimed in claim 11, wherein the storage unit is used for storing energy outputted from the DC energy source harvesting circuit and the AC energy source harvesting circuit.
